(19) United States
(12) Patent Application Publication
(10) Pub. No.: US 2010/0321944 A1
(43) Pub. Date: Dec. 23, 2010

(54) DETENT SPRING AND END CAP STRUCTURES FOR A VISOR VANITY

(75) Inventors: Taiyoh S. Afrik, Holland, MI (US); Philip Lehman, West Olive, MI (US); Dennis J. Fennema, Holland, MI (US); Kenneth Kreuze, Holland, MI (US); Thomas D. Brookhouse, Zeeland, MI (US)

Correspondence Address: DOBRUSIN & THENNISCH PC, 29 W LAWRENCE ST, SUITE 210, PONTIAC, MI, 48342, US

(73) Assignee: JOHNSON CONTROLS TECHNOLOGY COMPANY, Holland, MI (US)

(21) Appl. No.: 12/808,468

(22) PCT Filed: Dec. 17, 2008
(86) PCT No.: PCT/US08/87202

§ 371 Date: Aug. 30, 2010

Related U.S. Application Data
(60) Provisional application No. 61/014,402, filed on Dec. 17, 2007.

(51) Int. Cl. B60Q 3/02; B60J 3/00; B60J 3/02; G02B 5/08

(52) U.S. Cl. 362/492; 359/844; 296/97.5

(57) ABSTRACT

A vanity has a mirror and a cover panel that slides between an open position to reveal the mirror and a closed position to conceal the minor. The vanity includes an improved detent mechanism that is usable to maintain the cover panel in the open position, closed position and/or other positions A light source may be provided adjacent the mirror to illuminate an object to be viewed in the minor The vanity can be positioned in a visor that is attached to the vehicle using a slide-on-rod, where the visor rotates around the slide-on-rod between up and down positions The vanity can include an end cap assembly that activates and deactivates the light source depending on both the rotational position of the visor and the lateral position of the cover panel.

This application claims priority to U.S. Provisional Application 61/014,402, filed Dec. 17, 2007, which is incorporated herein by reference in its entirety.

### FIELD

This invention relates to a vanity for use in a vehicle. This invention relates more particularly to an improved detent spring for the vanity. This invention also relates more particularly to an end cap assembly for a lighted vanity usable to actuate a lighting system of the lighted vanity.

### BACKGROUND

Vanities for use within vehicles are generally known and are typically provided on one side of a visor, so that the visor may be folded-down to expose the vanity. The generally known vanities typically include a mirror, and may include a lighting system with a light source, such as a bulb and lens, located adjacent to the mirror and usable to illuminate an object to be viewed in the minor. Such vanities also typically include a cover panel or door that slides relative to the mirror, so that, when the visor is folded down, the cover panel or door may slide to an open position to expose the mirror to an occupant of the vehicle and then slide to a closed position to conceal the mirror.

Such vanities typically include a mechanism or assembly usable to keep the cover panel or door in the opened and closed positions, so the door does not move relative to the mirror unless operated by the occupant of the vehicle. Such vanities also typically include a switch mechanism that selectively activates the lighting system when the visor is in the down position and the cover panel or door is opened.

### SUMMARY

An embodiment of this invention relates to a vanity positioned within a visor and usable within a vehicle. The vanity includes a minor, a sliding cover panel or door and a detent spring assembly. The cover panel or door slides along a door track between a first position where the minor is concealed by the cover panel or door and a second position where the minor is revealed. The detent spring is positioned in the cover door and engages with detent features positioned along the door track to maintain the cover panel or door in any of one or more positions along the door track.

Another embodiment of this invention relates to a lighted vanity positioned within a visor and usable within a vehicle. The visor is mounted on a slide-on-rod and can be moved longitudinally along the slide-on-rod and can be rotated about the slide-on-rod between an up position and a down position. The vanity includes a mirror and a sliding cover panel or door. The cover panel or door slides along a door track between a first position where the mirror is concealed by the cover panel or door and a second position where the mirror is revealed. The vanity also includes a light source adjacent the mirror. An end cap assembly is provided on an end of the slide-on-rod carrier and includes a pair of electrically conductive members that selectively engage conductive members provided on the slide-on-rod as the visor is rotated relative to the slide-on-rod. In various exemplary embodiments, the end cap assembly also extends into the door track, such that the pair of electrically conductive members independently selectively engage structures provided on the sliding cover panel or door as the cover panel or door is moved between the open and closed positions.

These and other features and advantages of various exemplary embodiments of systems and methods according to this invention are described in, or are apparent from, the following detailed descriptions of various exemplary embodiments of various devices, structures and/or methods according to this invention.

### BRIEF DESCRIPTION OF THE DRAWINGS

Various exemplary embodiments of systems, structures and methods according to this invention will be described in detail, with reference to the following figures, wherein:

FIG. 1 is an exploded view of a vanity for a visor, including a bezel frame, a minor and a door that slides in the bezel frame, including one exemplary embodiment of a detent spring according to this invention;

FIG. 2 is a perspective view of the vanity door and detent spring shown in FIG. 1;

FIG. 3 is a perspective view of the assembled vanity shown in FIG. 1, with the door in a fully opened position such that the detent spring is engaged with the door open detent feature;

FIG. 4 is a perspective view of the assembled vanity shown in FIG. 1, with the door positioned between the fully opened position and a fully closed position such that the detent spring is disengaged from the door open detent feature;

FIG. 5 is a cross-sectional view of the assembled vanity shown in FIG. 3;

FIG. 6 is a cross-sectional view of the assembled vanity shown in FIG. 4;

FIG. 7 is an exploded view of a slide-on-rod assembly of a visor vanity and an end cap assembly according to this invention;

FIG. 8 is a perspective view of the assembled end cap assembly in an opened state;

FIG. 9 is a perspective view of the assembled end cap assembly in a closed state;

FIG. 10 is a perspective view of the assembled end cap assembly in a closed state and inserted into the end of the slide-on-rod assembly shown in FIG. 7;

FIG. 11 is a perspective view of the end cap of the end cap assembly in an opened state, showing various structural elements of the end cap;

FIG. 12 is a first perspective view of the assembled end cap assembly in an opened state and inserted into the end of the slide-on-rod assembly shown in FIG. 7, showing the relationship between the slide-on-rod and the conductive stampings;

FIG. 13 is a second perspective view of the assembled end cap assembly in an opened state and inserted into the end of the slide-on-rod assembly shown in FIG. 7, showing the relationship between the slide-on-rod and the conductive stampings;

FIG. 14 is a top perspective view of the assembled end cap assembly when assembled with a vanity of a visor, with a door of the vanity in an open position;

FIG. 15 is a bottom perspective view of the assembled end cap assembly when assembled with a vanity of a visor, when the door of the vanity in the open position;

FIG. 16 is a top perspective view of the assembled end cap assembly when assembled with the vanity of the visor, with the door of the vanity in a closed position;

FIG. 17 is a side cross-sectional view of the assembled end cap assembly when assembled with the vanity of the visor, showing the unloaded and preloaded positions of the conductive stampings; and

FIG. 18 is a second cross-sectional view of the assembled end cap assembly when assembled with the vanity of the visor, showing the offsets and clearances between the preloaded and operative positions of the conductive stampings.

### DESCRIPTION

It would be advantageous to provide a vanity for a vehicle with an improved detent mechanism or assembly that is usable to keep a cover panel or door in an opened position, a closed position and/or other positions. It would be further advantageous to provide a vanity for a vehicle having an improved detent mechanism or assembly that requires the same force feel for moving the cover panel or door from the closed position to the open position as from the open position to the closed position. It would also be advantageous to provide a vanity for a vehicle having an improved switch mechanism. It would be further advantageous to provide a vanity for a vehicle having an improved switch mechanism that activates a lighting system only when the visor is in the down position and the cover panel or door is in the opened position, and that deactivates the lighting system when the vanity is not in the down position and/or the cover panel is not in the opened position.

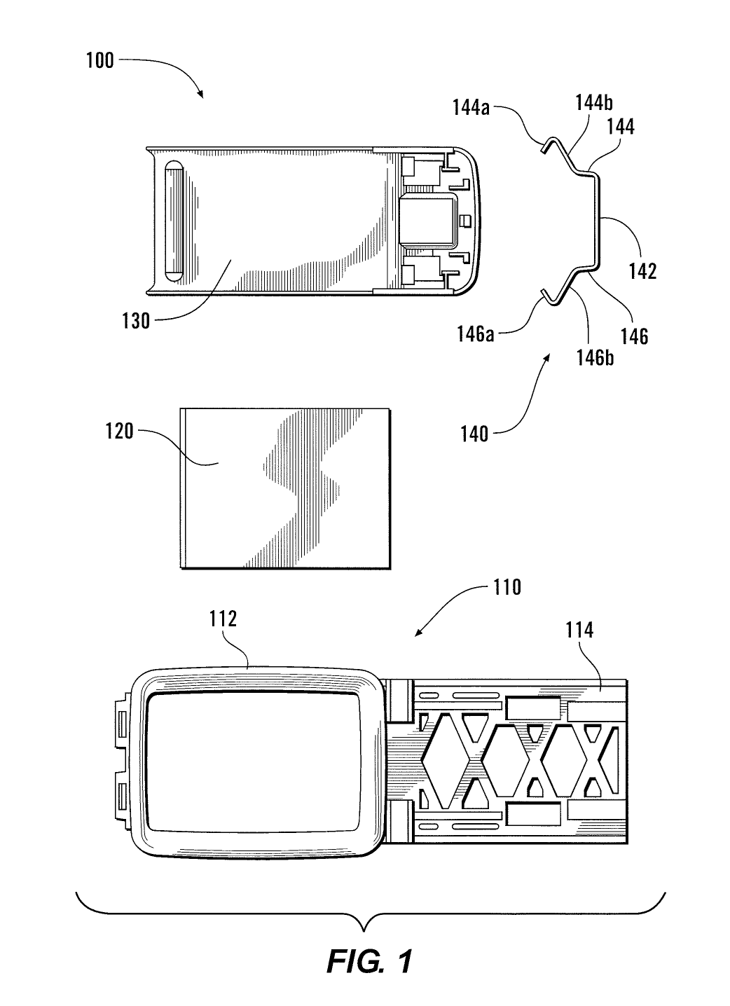

FIG. 1 is an exploded view of a vanity 100 for a visor. As shown in FIG. 1, the vanity 100 includes a bezel frame 110, a mirror 120 and a door 130 that slides in the bezel frame 110. The bezel frame 110 includes a bezel portion 112 that sits on the show surface of the visor and that surrounds a hole in the visor. The mirror 120 sits in the opening in the bezel portion 110. The bezel frame 110 also includes a door track 114 that the door 130 slides in. The door track 114 is located within the visor when the bezel frame 110 is assembled into the visor.

The door 130 includes one exemplary embodiment of a detent spring 140 according to this invention that engages with detent features provided in the door track 114 to maintain the door 130 in at least one position (e.g., at a fully closed position, a fully opened position and/or other desired positions). That is, the door track 114 will typically have a set of one or more detent features at a first position (e.g., one or more door open detent features at a first end of the door track 114), and may have another set of one or more detent features at a second position (e.g., one or more door closed detent features at a second end of the door track 114). However, there may be any number of sets of one or more detent features on the door track 114 located at any desired position along the door track 114.

As shown in FIG. 1, the detent spring 140 comprises a connecting portion 142 that connects together a first spring leg 144 and a second spring leg 146. The first spring leg 144 includes an inner leg portion 144a and an outer leg portion 144b, while the second spring leg 146 includes an inner leg portion 146a and an outer leg portion 146b. It should be appreciated that each of the first and second spring legs 144 and 146 are able to act as independent springs, rather than two portions of a single spring, due to the connecting portion 142 and structures of the vanity door 130. It should also be appreciated that, due to the isolated nature of the first and second spring legs 144 and 146, either of the first and second spring legs 144 and 146 may be omitted. In various exemplary embodiments, the detent spring 140 is formed of a wire of an elastically deformable metal, such as, for example, a drawn steel wire. However, it should be appreciated that the detent spring 140 can be made of any elastically deformable material that is sufficiently rigid to appropriately engage the detent features and that is robust enough to last the expected lifetime of the vehicle in which the visor will be installed. It should be appreciated that the detent spring 140 and/or the door track 114 may be provided with a lubricating coating or the like to reduce the friction between the detent spring and the door track 114, including the detent features.

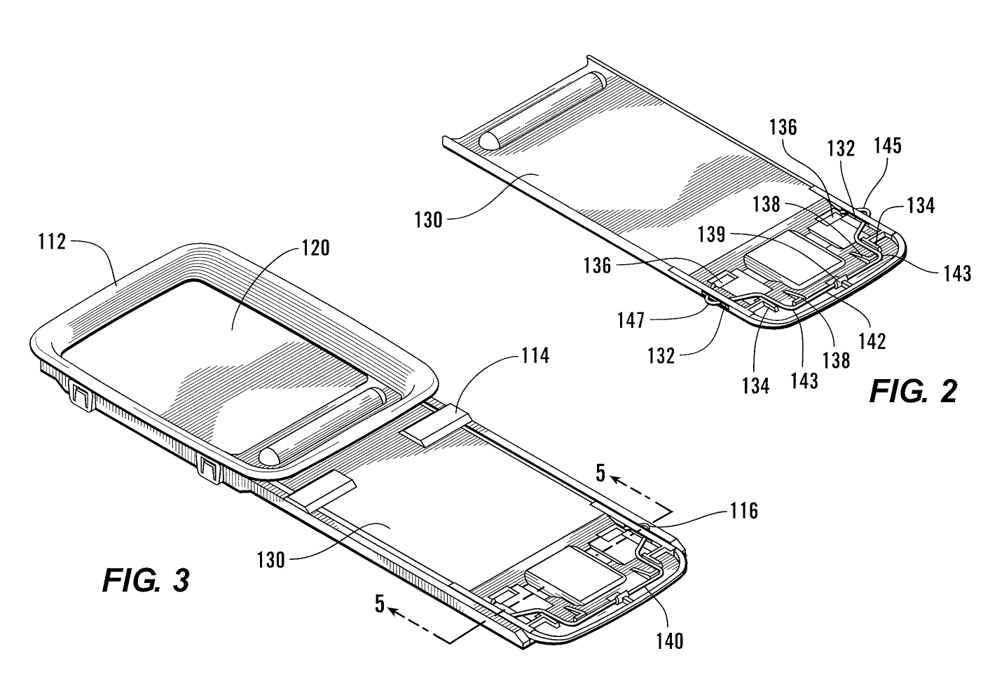

FIG. 2 is a perspective view of the vanity door 130 and the detent spring 140 shown in FIG. 1 with the detent spring 140 positioned in the vanity door 130. As shown in FIG. 2, the vanity door 130 includes structures 132-139 provided at an end of the vanity door 130 that remains hidden within the bezel frame 110 when the vanity door 130 is in the closed position. In the exemplary embodiment of the vanity door 130 shown in FIG. 2, the vanity door 130 includes a pair of slots 132, a pair of pre-load ribs 134, a pair of relief depressions 136, a pair of spring isolation ribs 138 and a detent spring mount 139.

Detent-engaging portions 145 and 147, which are located at the junction between the inner leg portions 144a and 146a and the outer leg portions 144b and 14b of the first and second spring legs 144 and 146, respectively, extend through the pair of slots 132 so that the detent-engaging portions 145 and 147 are able to engage detent features located at one or more desired locations on the door track 114.

The pre-load ribs 134 extend inwardly from the outer rim of the vanity door and act to compress the first and second spring legs 144 and 146 of the detent spring 140 inwardly. When prepared, the first and second spring legs 144 and 146 are not at right angles to the connecting portion 142, but are angled outwardly slightly. The pre-load ribs 134 force the first and second spring legs 144 and 146 inwardly, creating an outward bias of the spring legs 144 and 146, so that the spring legs 144 and 146 are at known positions relative to the vanity door 130 and require a known force to move the spring legs 144 and 146 inwardly to disengage from the detent features.

The relief depressions 136 lie under the free ends of the first and second spring legs 144 and 146. The relief depressions 136 ensure that those free ends do not inadvertently engage or catch on the surface of the vanity door 130, and thus interfere with the operation of the detent spring 140 as it engages with and disengages from the detent features on the door track 114.

The pair of spring isolation ribs 138 are positioned inwardly of the bent ends 143 of the first and second spring legs 144 and 146 that are connected to the connecting portion 142. The spring isolation ribs 138 bear against the connection portion 142 and isolate each of the first and second spring legs 144 and 146 from each other. That is, when one of the first or second spring legs 144 or 146 rotates outwardly to engage a detent feature or rotates inwardly to disengage from a detent feature, that first or second spring leg 144 or 146 is isolated from, and thus does not affect the other of the first or second spring leg 144 or 146, due to, at least in part, the spring isolation ribs 138. The detent spring mount 139 holds the connecting portion 142, and thus the detent spring 140, in place against the spring isolation ribs 138.

It should be appreciated that the various structures 132-139 of the vanity door 130 may be located at positions other than those shown in FIG. 2 without interfering with their functions. For example, the spring isolation ribs 138 may be positioned adjacent the first and second legs 144 and 146 rather than adjacent the connecting portion 142.

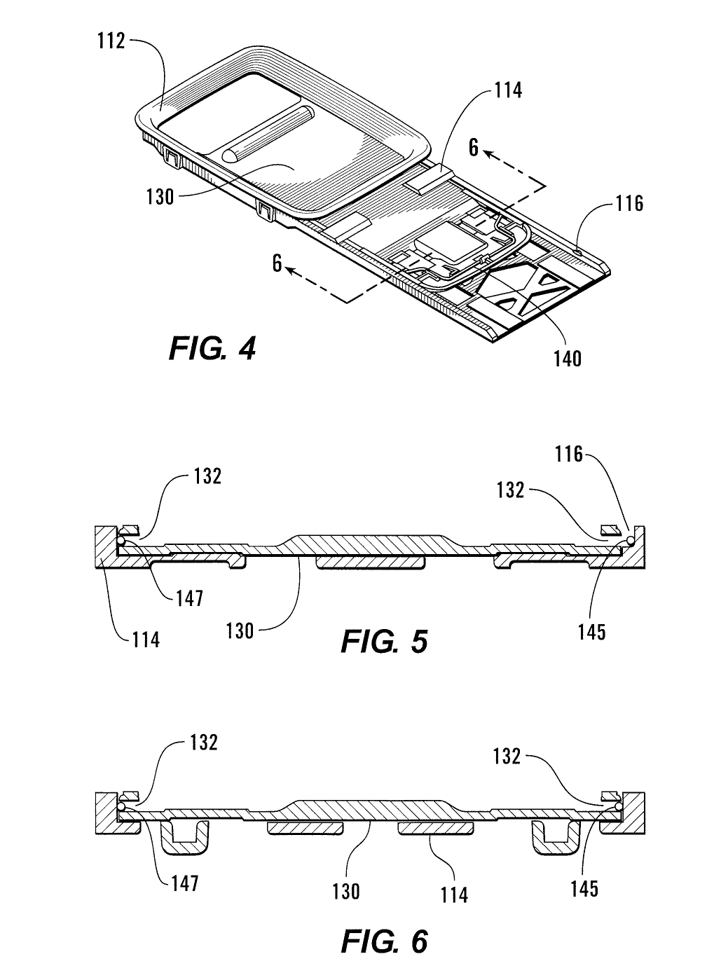

FIG. 3 is a perspective view of the assembled vanity 100 shown in FIG. 1, with the vanity door 130 in a fully opened position. When the vanity door 130 is in this fully opened position and/or when the vanity door 130 is in other desired positions, such as, for example, the fully closed position, the detent spring 140 engages with one or more detent features provided on the door track 114. In contrast, FIG. 4 is a perspective view of the assembled vanity 100 shown in FIG. 1, with the vanity door 130 positioned between desired detent positions, such as, for example, between the fully opened position and the fully closed position. When the vanity door 130 is between desired detent positions, such as, between the fully opened position and the fully closed position, the detent spring 140 is disengaged from the one or more detent features of the door track 114. FIGS. 3 and 4 show one of the detent features. In particular, they show a door open detent feature 116, which is located near the free end of the door track 114.

Typically, there will be at least one additional set of detent features provided along the door track 114, such as for example, a set of one or more door closed detent features. Typically, this additional set of detent features (e.g., the door closed detent features) will be located near the end of the door track 114 that is attached to the bezel portion 112. It should be appreciated that the detent features 116 are typically arcuate, sinusoidal or triangular depressions formed in the door track 114, in view of the acute angle formed by the bends in the first and second spring legs 144 and 146 that form the detent-engaging portions 145 and 147. However, it should be appreciated that the detent features 116 can use any shape that is appropriate for the shape of the detent-engaging portions 145 and 147.

It should be appreciated that, due to the orientation of the connection portion 142 of the detent spring in the door 130, along with the pre-load ribs 134, it may, in general, require less force, or at least give the impression of requiring less force, against the inner leg portions 144a and 146a of the first and second spring legs 144 and 146 to move the spring legs 144 and 146 inwardly than the force required against the outer leg portions 144b and 146b. This may occur, at least in part, because the pre-load ribs 134 also prevent the first and second spring legs 144 and 146 from compressing longitudinally, i.e., along the long axis of the vanity door. That is, when force is applied to the inner leg portions 144a and 146a, the first and second spring legs 144 and 146 are also being pushed away from the pre-load ribs 138. In contrast, when force is applied to the outer leg portions 144b and 146b, the first and second spring legs 144 and 146 are instead being pushed into the pre-load ribs 138.

It should be appreciated that, when the vanity door 130 is in the closed position, the detent-engaging portions 145 and 147 are engaged with a set of door closed detent features. To move the vanity door 130 from the closed position to the open position, as a vehicle occupant moves the vanity door from left to right (in the orientation shown in FIGS. 3 and 4), the right edge of the door closed detent features bear against the inner portions 144a and 146a of the spring legs 144 and 146 so that the spring legs 144 and 146 will disengage from the door closed detent features. In contrast, when the vanity door 130 is in the open position, the detent-engaging portion 145 is engaged with the door open detent feature 116. To move the vanity door 130 from the open position toward the closed position, as the vehicle occupant moves the vanity door from right to left (in the orientation shown in FIGS. 3 and 4), the left edge of the door open detent feature 116 bears against the outer portion 144b of the spring leg 144, so that the spring leg 144 will disengage from the door open detent feature 116.

As noted above, less force may be required to move the vanity door 130 from the door closed position than may be required to move the vanity door 130 from the door open position. However, vehicle occupants typically want and expect to use the same amount of force in both circumstances. In the exemplary embodiment shown in FIGS. 3 and 4, this is achieved by using two door-closed detent features, one on each side of the door track 114, but only a single door-open detent feature 116. It should be appreciated that this can be achieved in a variety of other ways. For example, detent features of various shapes, sizes and depths may be provided at one or more desired locations such that different amounts of force are required to move the vanity door 130 from the desired locations.

FIG. 5 is a cross-sectional view of the assembled vanity shown in FIG. 3, through the line 5-5. FIG. 6 is a cross-sectional view of the assembled vanity shown in FIG. 4; through the line 6-6. As shown in FIGS. 5 and 6, when the vanity door 130 is in the fully open position, the detent engaging portion 145 of the first spring leg 144 extends outwardly from the vanity door 130, through the slot 132 and into the detent feature 116 of the door track 114. At the same time, because there is not a corresponding detent feature for the second spring leg 146, the detent engaging portion 147 is held within the slot 132 by the side wall of the door track 114. As shown in FIG. 6, when the vanity door 130 is between the door open and door closed positions, both of the detent-engaging portions 145 and 147 are held within the slots 132 by the side walls of the door track 114. It should be appreciated that the vanity door 130 may be held in other desirable locations in addition to or in place of the door open and door closed positions. As such, the one or more detent features may be located at any desirable location along the door track 114.

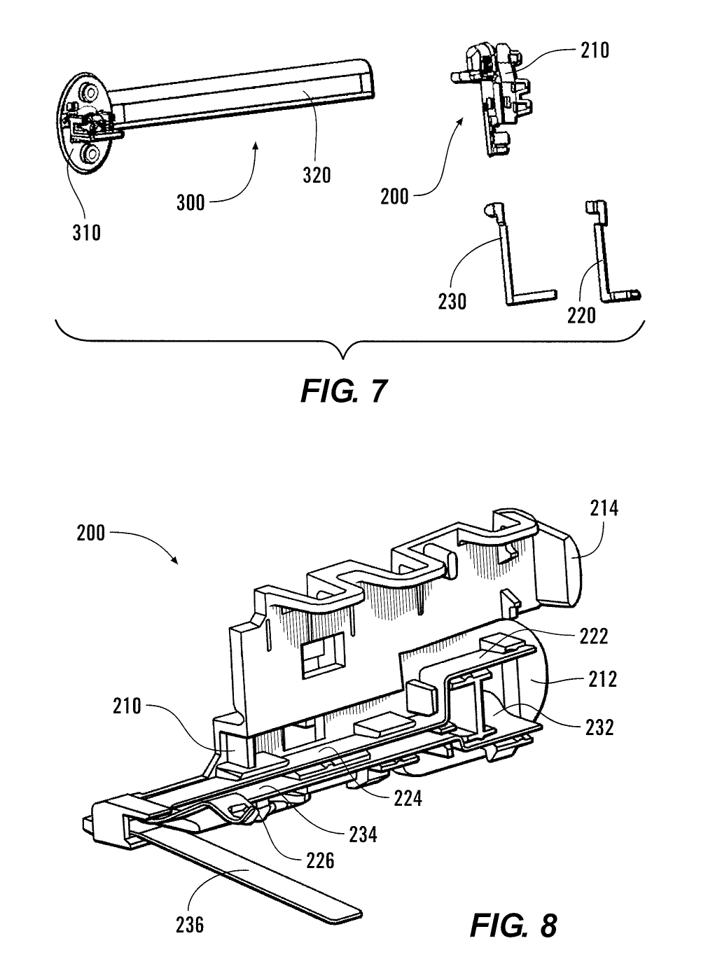

FIG. 7 is an exploded view of a slide-on-rod assembly 300 for a visor and one exemplary embodiment of an end cap assembly 200 according to this invention. As shown in FIG. 7, the end cap assembly 200 includes an end cap 210, a first stamping 220 (e.g., an actuator stamping) and a second stamping 230 (e.g., a fixed stamping). The slide-on-rod assembly 300 includes a bracket 310 and a slide-on-rod carrier 320. The end cap 210 of the end cap assembly 200 is inserted into the slide-on-rod carrier 320.

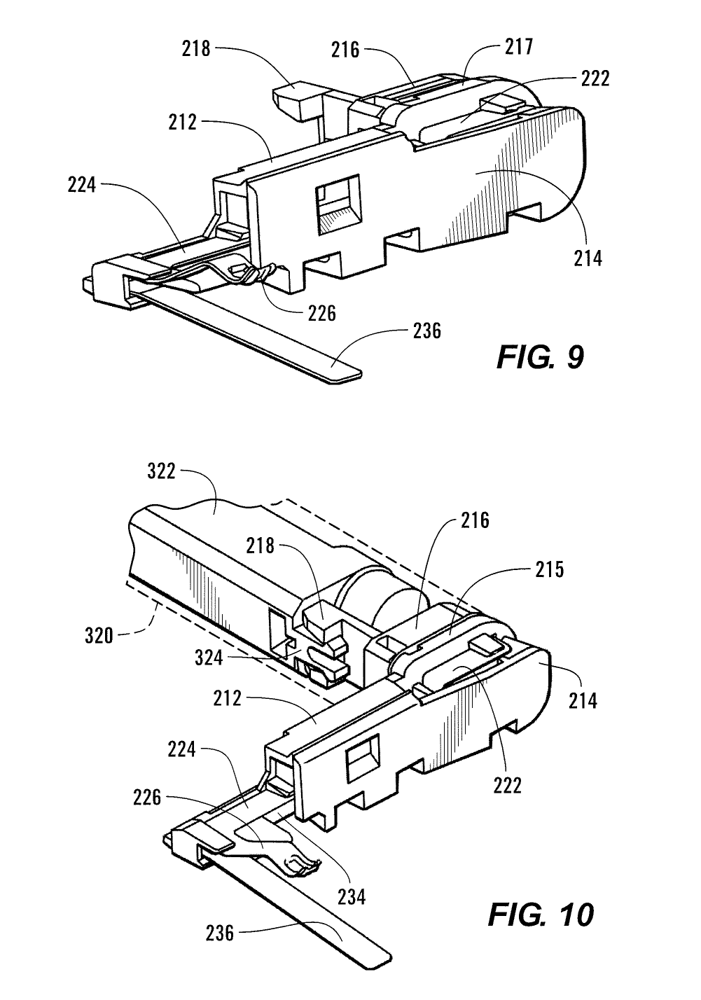

FIG. 8 is a perspective view of the assembled end cap assembly 200 shown in FIG. 7 in an opened state. FIG. 9 is a perspective view of the assembled end cap assembly 200 in a closed state. As shown in FIGS. 8 and 9, in various exemplary embodiments, the end cap 210 includes a first portion 212 and a second portion 214 that are connected with a living hinge that allows the second portion 214 to be folded down and closed against the first portion 212.

As shown in FIG. 8, when in the opened state, the first and second stampings 220 and 230 can be inserted into the first portion 212 of the end cap 210. It should be appreciated that, typically, the stampings will be stamped from a sheet of thin conductive material, which will typically be a metal such as aluminum, copper or the like. However, it should be appreciated that any known or later-developed conductive, elastically-deformable material can be used for the first and second stampings 220 and 230. It should also be appreciated that other appropriate processes for making the stampings 220 and 230, other than stamping, can be used. Thus, it should be understood that the term stampings does not limit these elements to being made by a stamping process.

As shown in FIG. 8, first contact portions 222 and 232 of the first and second stampings 220 and 230, respectively, are located within the end cap 210 and extend into a hole or void formed in the first portion 212 of the end cap 210. In contrast, as shown in FIGS. 8 and 9, second contact portions 226 and 236 of the first and second stampings 220 and 230, respectively, extend outside of the end cap 210, in a direction parallel to, but opposite from, the direction that the first contact portions 222 and 232 extend. The first and second contact portions 222 and 226, and 232 and 236, respectively, of the first and second stampings 220 and 230 are connected by third or connecting portions 224 and 234. As shown in FIG. 8, the connecting portions 224 and 234 are held in place by various structures formed within the end cap 210.

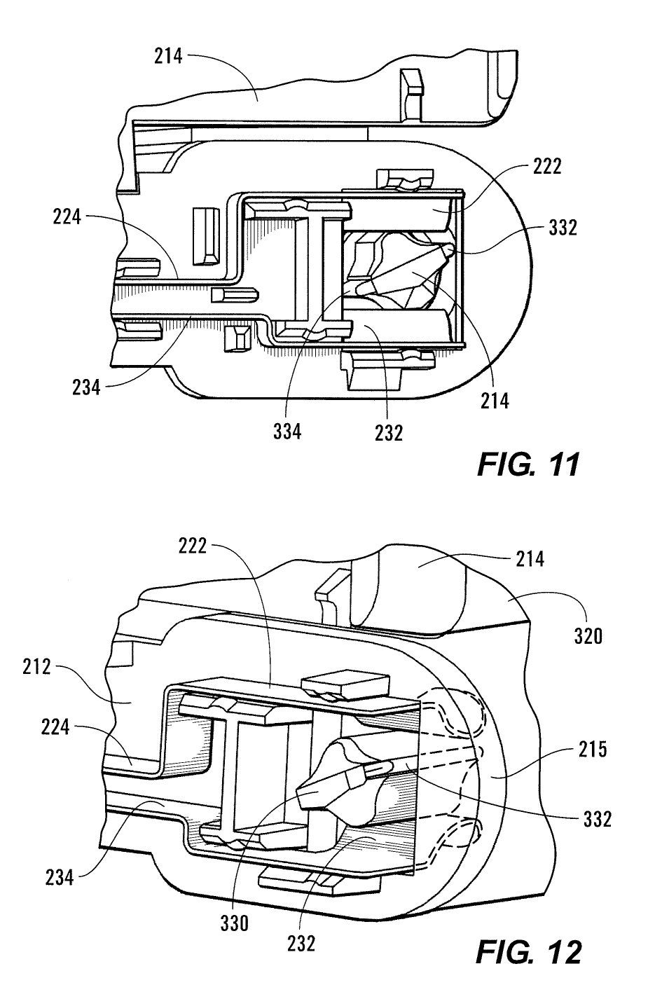

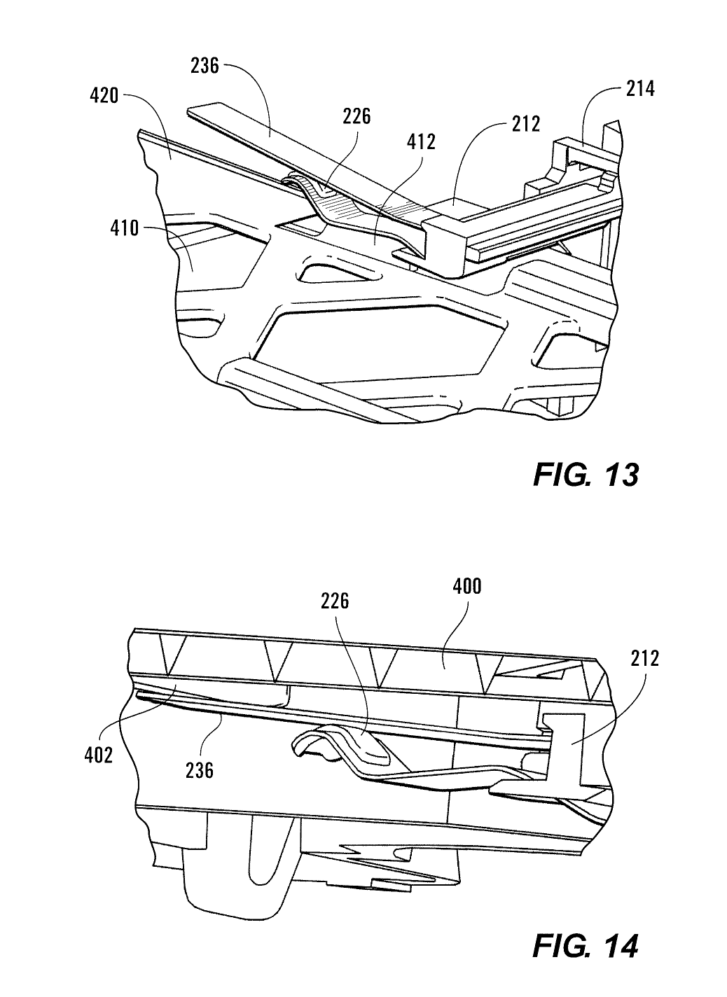

FIG. 10 is a perspective view of the assembled end cap assembly 200 in a closed state and inserted into the end of the slide-on-rod carrier 320 of the slide-on-rod assembly 300 shown in FIG. 7. FIG. 11, is a perspective view of the end cap 210 of the end cap assembly 200 in an opened state. FIGS. 12 and 13 are first and second perspective views, respectively, of the assembled end cap assembly 200 in an opened state and inserted into the end of the slide-on-rod carrier 320 of the slide-on-rod assembly shown in FIG. 7, showing the relationship between a slide-on-rod 314 and the conductive first and second stampings 220 and 230. As shown in FIG. 10, the slide-on-rod carrier 320 of the slide-on-rod assembly 300 houses a detent spring assembly 322 that rotates around the slide-on-rod 314 to allow the visor to be rotated to various positions between the headliner and the windshield or a window of the vehicle.

A mounting portion 216 of the first portion 212 of the end cap 210 extends into the hollow slide-on-rod carrier 320 to securely mount the end cap 210 onto the slide-on-rod carrier 320. As shown in FIG. 10, when the mounting portion is inserted into the end of the slide-on-rod carrier 320, a latch structure 218 passes over a pair of arms 324 extending from the detent spring assembly 322 to secure the end cap 210 to the slide-on-rod carrier 320. A collar portion 215 of the first portion 212 of the end cap 210 rests against the end of the slide-on-rod carrier 320 to control how deeply the mounting portion 216 extends into the hollow slide-on-rod carrier 320.

As shown in FIG. 11, in one exemplary embodiment, the end cap 210 includes various structural elements 251-257. These structural elements include stop ribs 251, an increased blend or radius between a main portion 259 of the second portion 214 of the end cap 210 and catches 258 extending from the main portion 259, stiffening ribs 253 and pinch ribs 254 provided on the main portion 259, poka-yoke ribs 255 and 256 provided on the first portion 212 of the end cap 210, and strengthened snaps 257 on the first portion 212 that engage the catches 258 on the main portion 259 when the end cap 210 is closed.

As shown in FIGS. 12 and 13, the slide-on-rod 314 has a pair of conductive contacts 332 and 334 mounted in it. The conductive contacts 332 and 334 each extend along the length of the slide-on-rod 314. As the visor, and thus the slide-on-rod carrier 320 and the end cap 210, are rotated about the slide-on-rod 314, the conductive contacts 332 and 334 engage and disengage from the first contact portions 222 and 232 of the first and second stampings 220 and 230, respectively. Thus, the first contact portions 222 and 232 and the conductive contacts 332 and 334 form a first switch. In particular, the slide-on-rod carrier 320, and thus the visor and the end cap 210, are oriented relative to the slide-on-rod 314, such that, when the visor is in an up position, with the inner face of the visor facing the headliner, the first and second stampings 220 and 230 are disengaged from the conductive contacts 332 and 334, opening the first switch. In contrast, when the visor is in a down position, such that the inner face of the visor is facing the occupant, the first and second stampings 220 and 230 are engaged with the conductive contacts 332 and 334, closing the first switch.

FIG. 14 is a top perspective view of the assembled end cap assembly 200 when assembled with a vanity of a visor, with a door 410 of the vanity in an open position.

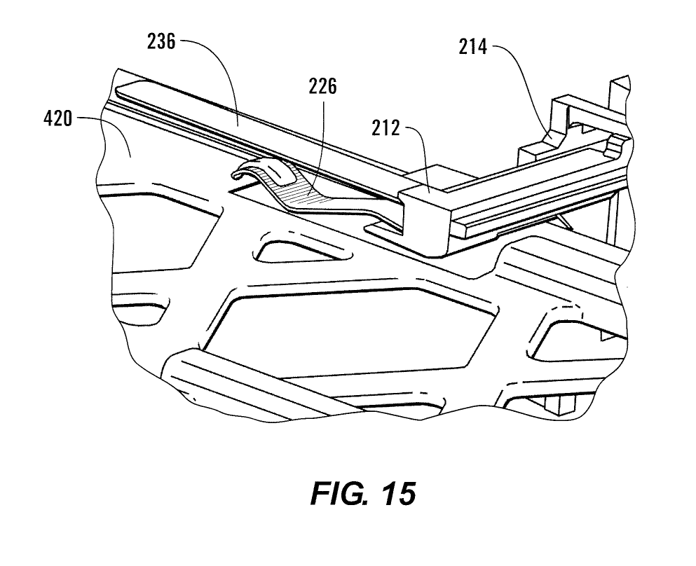

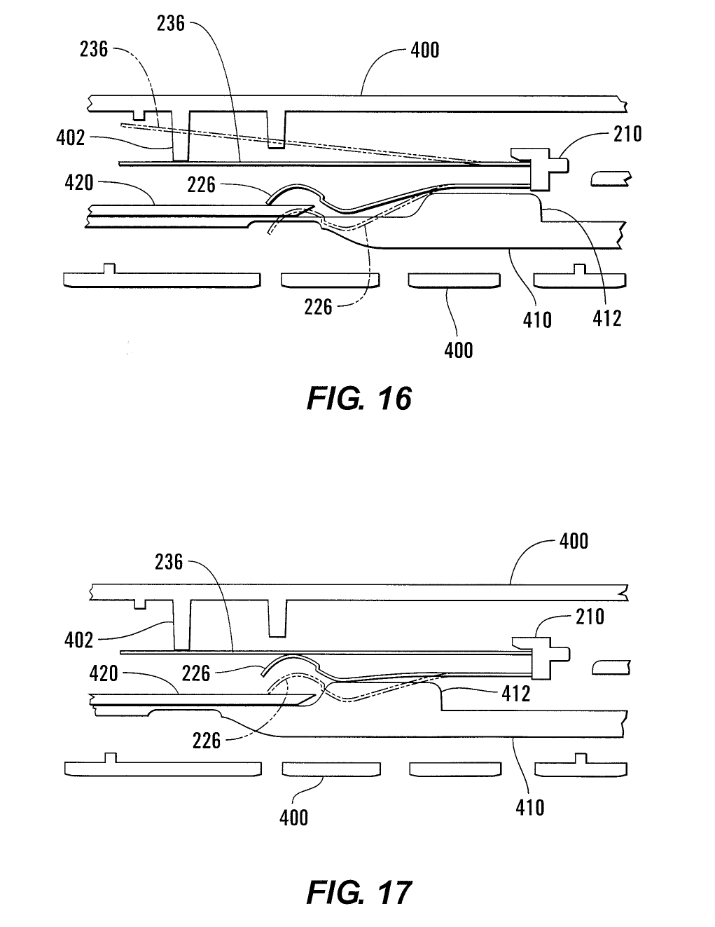

FIG. 15 is a bottom perspective view of the assembled end cap assembly 200 when assembled with a vanity of a visor 400, with the door 410 of the vanity in the open position. FIG. 16 is a top perspective view of the assembled end cap assembly 200 when assembled with the vanity of the visor, with the door 410 of the vanity 400 in a closed position. As shown in FIGS. 14-16, the second contact portions 226 and 236 of the first and second stampings 220 and 230, when the slide-on-rod carrier 320 and the end cap 210 are inserted into the visor 400, extend along a door track 420 along which the door 410 slides between a closed position and an open position. When the door 410 is in the open position, the mirror of the vanity is exposed to the occupant of the vehicle.

As shown in FIGS. 14 and 15, when the door 410 is in the open position, a projection 412 that extends from the door 410 towards the second contact portions 226 and 236 of the first and second stampings 220 and 230 engages the second contact portion 226 of the first stamping 220, forcing it towards the second contact portion 236 of the second stamping 230. Thus, the second contact portions 226 and 236 and the projection 412 form a second switch. In particular, as shown in FIG. 16, when the door is closed, the projection 412 is disengaged from the second contact portion 226 of the first stamping 220, such that the second contact portion 226 of the first stamping 220 is disengaged from the second contact portion 236 of the second stamping 230, opening the second switch. In contrast, as shown in FIGS. 14 and 15, when the door is in the open position, such that the minor is visible to the occupant, the projection 412 engages the second contact portion 226 of the first stamping 220, forcing the second contact portion 226 of the first stamping 220 into contact with the second contact portion 236 of the second stamping 230, closing the second switch.

It should be appreciated that the slide-on-rod 314 with the conductive contacts 332 and 334, the first and second stampings 220 and 230 and the projection 412 on the door 410 form a two-switch circuit usable to connect power to, for example, a light on the vanity of the visor 400. In particular, the two switches will be closed, and thus will supply power to the light, only when the visor 400 is in the down position and the vanity door 410 is open. Otherwise, if either the visor 400 is in the up position or the vanity door 410 is closed, at least one of the two switches will be open, removing power from the vanity light. Since it is not useful to supply power to the vanity light when the visor 400 is in the up position or when the vanity door 410 is in the closed position, this avoids unnecessarily or undesirably supplying power to the vanity light.

It should be appreciated that other features, besides lights, may be provided and may be powered by the first and second switches. Likewise, the first and second switches may be used to transmit electrical signals in addition to power. For example, a data connection may be provided across the first and second switches.

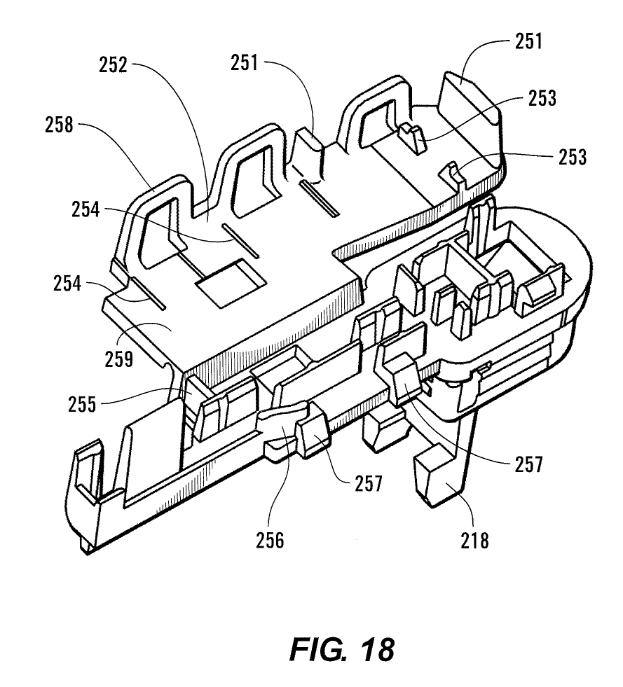

To ensure that the second switch opens and closes reliably as the vanity door 410 moves to and from the open position, the first and second stampings 220 and 230 are initially manufactured so that the second contact portions 226 and 236 are oriented so they extend away from each other. To move the second contact portions 226 and 236 toward each other to preload positions, appropriate structures are provided on the visor 400 and the door track 420. FIGS. 17 and 18 illustrate exemplary embodiments of these structures.

FIG. 17 is a side cross-sectional view of the assembled end cap assembly 200 when assembled with the vanity of the visor, showing the unloaded and preloaded positions of the second contact portions 226 and 236 when the door is closed. FIG. 18 is a second cross-sectional view of the assembled end cap assembly 200 when assembled with the vanity of the visor, showing the preloaded and operative positions of the second contact portions 226 and 236 when the door is open. As shown in FIGS. 17 and 18, a preload rib 402 extends from the visor 400 towards the door 410. The free end of the second contact portion 236 of the second stamping 230, when the end cap 210 and the slide-on-rod carrier 320 are inserted into the visor 400, rests against the pre-load rib 402 and is thus placed into its pre-load position. Likewise, as shown in FIG. 17, the end of the second contact portion 226 of the first stamping 220, when the end cap 210 and the slide-on-rod carrier 320 are inserted into the visor 400, rests against the door track 420, and is thus placed in its preload position. Exemplary unloaded positions of the second contact portions 226 and 236 are each shown in phantom in FIG. 17.

As shown in FIG. 18, when the door 410 is placed into the open position, the projection 412 bears against the second contact portion 226 of the first stamping 220 to close the second switch. FIG. 18 represents exemplary offsets between the preloaded and operative positions for the second contact portion 226 of the first stamping 220.

It is also important to note that the construction and arrangement of the elements of each of the detent spring and the end cap assembly, as discussed above with respect to the disclosed exemplary embodiments, are illustrative only. Although only a few embodiments of the vanity and of the end cap according to the invention disclosed above have been described in detail in this disclosure, it should be appreciated that many modifications are possible (e.g., variations in sizes, dimensions, structures, shapes and proportions of the various elements, values of parameters, mounting arrangements, use of materials, colors, orientations, etc.) without materially departing from the novel teachings and advantages of the disclosed subject matter. For example, elements shown as integrally formed may be constructed of multiple parts or elements shown as multiple parts may be integrally formed. Similarly, the operation of the interfaces (e.g., clamps, etc.) may be reversed or otherwise varied, the length or width of the structures and/or members or connector or other elements of the system may be varied, the nature or number of adjustment positions provided between the elements may be varied (e.g., by variations in the number of engagement slots or size of the engagement slots or type of engagement).

It should be noted that the elements and/or subassemblies of the visor, vanity, detent spring and/or end cap assembly may be constructed from any of a wide variety of materials that provide sufficient strength or durability, in any of a wide variety of colors, textures and combinations. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

While these inventions have been described in conjunction with the exemplary embodiments outlined above, various alternatives, modifications, variations, improvements and/or substantial equivalents, whether known or that are or may be presently foreseen, may become apparent to those having at least ordinary skill in the art. Accordingly, the exemplary embodiments of these inventions, as set forth above, are intended to be illustrative, not limiting. Various changes may be made without departing from the spirit or scope of these inventions. Therefore, these inventions are intended to embrace all known or earlier developed alternatives, modifications, variations, improvements and/or substantial equivalents.

1. A vanity for a visor for a vehicle, comprising:
a mirror;
a door track having a plurality of detent features, at least one detent feature is provided at at least one of a first position and a second position along the door track;
a cover door that slides along the door track to selectively cover and expose the mm oi, the cover door comprising:
a detent spring mount; and
a detent spring mounted to the cover door using the detent spring mount and comprising:
a connecting portion, and a first spring portion connected to a first end of the connecting portion comprising an inner leg and an outer leg connected together at a detent portion, wherein:
the detent portion is extendable beyond an outer dimension of the cover door;
and
the connecting portion is held in the detent spring mount.

2. The vanity of claim 1 wherein:
the detent spring further comprises a second spring portion connected to a second end of the connecting portion, the second spring portion comprising an inner leg and an outer leg connected together at a detent portion; and
the detent portion of the second spring is extendable beyond an outer dimension of the first surface of the cover door.

3. The vanity of claim 1, wherein:
the cover door further comprises a slot for each spring portion; and
the detent portion of each spring portion extends through the corresponding slot m the cover door.

4. The vanity according to claim 1, wherein the cover door comprises a pan of opposing walls extending from a first surface and the detent portions of the first and second spring portions are extendable through slots provided in opposite ones of the pan of opposing walls.

5. The vanity according to claim 4, wherein a pair of detent features is provided at one of the first position and the second position and a single detent feature is provided at the other of the first position and the second position

6. The vanity according to claim 5, wherein at least one of the number, size and shape of detent features provided at the first position are different than the number, size and shape of detent features provided at the second position.

7. The vanity according to claim 5, wherein, for each of the at least first and second positions, at least one of the number, size and shape of detent features is selected to provide a desired amount of perceived force for moving the cover door from that first or second position.

8. The vanity according to claim 7 wherein, at least the perceived force for moving the cover door from the first position is the same as at least the perceived force for moving the cover door from the second position.

9. The vanity according to claim 1, further comprising: a plurality of pre-load ribs, and a plurality of spring isolation ribs.

10. The vanity according to claim 9, wherein the plurality of pre-load ribs and the plurality of spring isolation ribs each extend from the same surface of the cover door.

11. A visor for a vehicle, comprising:
a visor body;
a slide-on-rod carrier positioned in the visor body;
a slide-on-rod positioned m the slide-on-rod carrier, a pair of conductive members extending from the slide-on-rod;
a vanity positioned in the visor body, the vanity including a lighting mechanism, a door track and a cover door that slides m the door track between an open position and a closed position; and
an end cap assembly, comprising:
an end cap having a first portion and a second portion;
a first conductive member having a first contact portion, a second contact portion and a connecting portion extending between the first and second contact portions, and
a second conductive member having a first contact portion, a second contact portion and a connecting portion extending between the first and second contact portions, wherein:
the first and second conductive members are positioned m the end cap such that the first contact portions extend into a hole provided m the first portion of the end cap and the second contact portions extend from the second portion of the end cap;
the first portion of the end cap is positioned in the slide-on-rod carrier such that the first contact portions engage with and disengage from the conductive members provided on the slide-on-rod depending on a rotational position of the visor body relative to the slide-on-rod,
the second portion of the end cap extends into the door track such that the second contact portions engage with each other and disengage from each other depending on a position of the cover door within the door track; and
the lighting mechanism is activated only when the first contact portions are engaged with the conductive members on the slide-on-rod and the second contact portions are engaged with each other.

12. The visor according to claim 11 wherein the cover door comprises a projection that selectively forces the second contact portions toward each other until they are engaged with each other.

13. The visor according to claim 12 wherein the projection forces the second contact portions towards each other when the cover door is in an open position and does not force the second contact portions towards each other when the cover door is in a closed position.

14. The visor according to claim 13 wherein the projection forces the second contact portion of the first conductive member toward the second contact portion of the second conductive member when the cover door is in the open position.

15. The visor according to claim 11 wherein the vanity comprises:
a mirror;
a door track having a plurality of detent features, at least one detent feature is provided at at least one of a first position and a second position along the door track;
a cover door that slides along the door track to selectively cover and expose the mm oi, the cover door comprising:
a detent spring mount; and
a detent spring mounted to the cover door using the detent spring mount and comprising:
a connecting portion, and a first spring portion connected to a first end of the connecting portion comprising an inner leg and an outer leg connected together at a detent portion, wherein:
the detent portion is extendable beyond an outer dimension of the cover door;
and
the connecting portion is held in the detent spring mount.

16. The visor according to of claim 11, wherein the first contact portions engage with each other when the visor is m a use position and the first contact portions disengage from each other when the visor is in a stored position.

17. The visor according to claim 16, wherein:
the detent spring further comprises a second spring portion connected to a second end of the connecting portion, the second spring portion comprising an inner leg and an outer leg connected together at a detent portion; and
the detent portion of the second spring is extendable beyond an outer dimension of the first surface of the cover door.

18. The visor according to claim 16, wherein:
the cover door further comprises a slot for each spring portion; and
the detent portion of each spring portion extends through the corresponding slot m the cover door.

19. The visor according to claim 16, wherein the cover door comprises a pan of opposing walls extending from a first surface and the detent portions of the first and second spring portions are extendable through slots provided in opposite ones of the pan of opposing walls.

20. The visor according to claim 19, wherein a pair of detent features is provided at one of the first position and the second position and a single detent feature is provided at the other of the first position and the second position.
